(19) United States
(12) Patent Application Publication
(10) Pub. No.: US 2009/0130251 A1
(43) Pub. Date: May 21, 2009

(54) DUAL COATED CONFECTIONERY PRODUCT

(75) Inventors: Georgina Perry, Hoboken, NJ (US); Mark Jarrard, Reading, PA (US); Ongkar Pershad, Yonkers, NY (US); Deborah L. Watson, Haskell, NJ (US); Simone A. O'Neill, Wayne, NJ (US); Yannick Benoit, Prunay en Yvelines (FR); Jose Saudemont, Sailly en Ostrevent (FR); Sylvie Lagache, Marcq en Baroeul (FR)

Correspondence Address: HOFFMANN & BARON, LLP, 6900 JERICHO TURNPIKE, SYOSSET, NY, 11791, US

(73) Assignee: CADBURY ADAMS USA LLC, Parsippany, NJ (US)

(21) Appl. No.: 12/274,696

(22) Filed: Nov. 20, 2008

Related U.S. Application Data
(60) Provisional application No. 60/989,247, filed on Nov. 20, 2007.

(51) Int. Cl. A23G 4/20; A23G 3/54

(52) U.S. Cl. 426/5; 426/103; 426/660

(57) ABSTRACT

The present invention is directed generally to dual coated compositions for soft confectionery compositions and products containing the same. More particularly, the present invention relates to a non-particulate coating and a particulate coating for candy compositions where the particulate coating can include an acid blend in particulate form.

### CROSS-REFERENCE TO RELATED APPLICATIONS

The present application claims priority to U.S. Provisional Application No. 60/989,247, filed Nov. 20, 2007, the contents of which are incorporated by reference in their entirety.

### FIELD

The present invention is directed generally to dual coated compositions for soft confectionery compositions and products containing the same. More particularly, the present invention relates to a non-particulate coating and a particulate coating for candy compositions where the particulate coating can include an acid blend in particulate form.

### BACKGROUND

Coatings may be added to confectionery compositions in order to provide additional colors, flavors, and textures. One desirable coating includes an acidic component which provides a sour taste upon consumption. Such a coating may be present in a solid or particulate coating. Commonly the coating is a sugar and acid mixture in particulate form.

In traditional particulate coating of confectionery compositions, the confectionery is subjected to a high temperature steaming method, which tackifies the surface of the confectionery product. The tackified product is then coated with a particulate coating composition, via any number of methods. Traditionally, the candy composition is singly coated with the particulate coating.

There is a need for a dual-coated candy composition that may be coated with a non-particulate coating layer and a particulate coating layer.

### SUMMARY

In one embodiment, there is provided a confectionery product including a confectionery base, a first non-particulate coating and a second particulate coating.

In some embodiments, the confectionery product may include a second particulate coating where the second coating is an acid blend. In particular, the second particulate coating may be an acid blend of from about 50% to about 65% lactic acid by weight of the acid blend. In some embodiments, the acid blend may have a particle size of from about 25 to about 710 microns. In some other embodiments, the second particulate coating may include a sweetener.

In other embodiments, the confectionery product may include a center-fill confectionery region, where the confectionery base at least partially surrounds the center-fill confectionery region.

In another embodiment, there is provided a method of preparing a confectionery product, the method including the steps of: preparing a confectionery base composition; forming the confectionery base composition into a unit; coating the unit with a first coating; and coating the unit with a second coating; where at least one of the first or second coating includes a particulate coating.

In some embodiments, at least one of the first or second particulate coating of the method may include an acid. In other embodiments, at least one of the first or second particulate coating of the method may include a sweetener. In another embodiment, the particulate coating may include at least one encapsulated ingredient, the encapsulated ingredient including a component selected from the group consisting of: acids, sweeteners, flavors, sensates, functional ingredients, and combinations thereof.

In another embodiment, there is provided a chewing gum product including an elastomer region, a first non-particulate coating and a second particulate coating.

In another embodiment, there is provided a method of preparing a chewing gum product, the method including the steps of: preparing an elastomeric composition; forming the elastomeric composition into a unit; coating the unit with a first coating; and coating the unit with a second coating; where at least one of the first or second coating includes a particulate coating.

In some embodiments, the step of coating the individual piece with a first coating may include soft panning the individual piece, or the step of coating the individual piece with a first coating may include hard panning the individual piece. In other embodiments, the particulate coating may include an acid, and in other embodiments, the particulate coating may include a sweetener.

In still other embodiments, the method may include forming a center-fill region, where the elastomer region at least partially surrounds the center-fill region.

### DETAILED DESCRIPTION

As used herein, the term “confection”, or “confectionery” or “confectionery base” may include any conventional hard or soft confectionery composition, such as gummy candy or “gummi” confections (gummy candy includes a hydrocolloid texturizing agent such as gelatin alone or in combination with other texturizing agents). Also included are those chewable forms such as soft candies including, but not limited to, gum drops, licorice, fruit snacks, starch based jellies, gelatin based jellies, pectin based jellies, carageenan based jellies, agar based jellies, konjac based jellies, jelly beans, chewy candy, starch candy, nougat, nougatine, toffee, taffy, marshmallow, fondant, fudge, marzipan, chocolate, compound coating, carob coating, chewing gum, and caramel. Also included are confections such as compressed tablets, candy floss (also known as cotton candy), hard boiled candy, nut brittles, pastilles, pralines, nonpareils, dragees, lozenges, sugared nuts, comfits, and aniseed balls. The basis of soft candy confections is generally a sugar/glucose syrup or a polyol/polyol syrup or sugar/polyol combination and a gelatinizing agent, the latter of which may be gelatin, agar, gum arabic, maltodextrin, pectin, carageenan, konjac, modified starches or combinations thereof. Various other gums (also referred to as hydrocolloids) may also be used. The gelatinizing material may be desirably dissolved in water or otherwise hydrated prior to mixing with the sugar/glucose syrup combination. If a hydrocolloid such as pectin is used as the gelatinizing agent, then the pectin is desirably dry mixed with a portion of the sugar or bulk sweetener prior to addition of the dry mixture to water.

As used herein, the term “chewing gum region”, “chewing gum composition”, “chewing gum base”, “gum base”, “elastomer region”, “elastomeric region” and “elastomeric composition” refer to a confectionery base region/composition that includes at least one elastomer. Further, such regions may include various additional components, such as, for example, bulking agents, waxes, elastomer solvents, emulsifiers, plasticizers, fillers and mixtures thereof. The elastomers (rubbers) employed in the gum base will vary greatly depending upon various factors such as the type of gum base desired, the consistency of gum composition desired and the other components used in the composition to make the final chewing gum product.

The elastomers (rubbers) employed in the elastomer region or gum base will vary greatly depending upon various factors such as the type of gum base desired, the consistency of gum composition desired and the other components used in the composition to make the final chewing gum product. The elastomer may be any water-insoluble polymer known in the art, and includes those gum polymers utilized for chewing gums and bubble gums. Illustrative examples of suitable polymers in gum bases include both natural and synthetic elastomers. For example, those polymers which are suitable in gum base compositions include, without limitation, natural substances (of vegetable origin) such as chicle, natural rubber, crown gum, nispero, rosidinha, jelutong, perillo, niger gutta, tunu, balata, guttapercha, lechi capsi, sorva, gutta kay, and the like, and mixtures thereof. Examples of synthetic elastomers include, without limitation, styrene-butadiene copolymers (SBR), polyisobutylene, isobutylene-isoprene copolymers, polyethylene, polyvinyl acetate and the like, and mixtures thereof.

As used herein, the term “center-fill” refers to the innermost region of a confectionery product. The term “center-fill” does not necessarily imply symmetry of a confectionery product, only that the “center-fill” is within another region of the product. In some embodiments, the center-fill may be substantially symmetric and in others, the center-fill may not be symmetric of the confectionery piece. In some embodiments, more than one center-fill may be present. A center-fill may include solid, liquid, gas and mixtures thereof. The term “liquid” in the context of a center-fill includes fluid materials as well as semi-solid or gel materials. The center-fill can be aqueous, non-aqueous, or an emulsion.

As used herein, the terms “coating” or “coating region” are used to refer to a region of a confectionery product that at least partially surrounds the confectionery base. In some embodiments, the coating may be amorphous or crystalline and it may be non-particulate or particulate. Particulate coatings may be referred to as “sanding” compositions or “dusting” compositions. Confections with such particulate coatings may be referred to as sanded or dusted. There may be one or more various coatings on the confectionery product, including a particulate and non-particulate coating. In some embodiments, the coating includes a first non-particulate coating and a second particulate coating. Non-particulate coatings can include a range of textures from soft to hard depending on their moisture content and composition. As used herein, “soft panned” coatings refer to non-particulate coatings where the coating provides a soft bite as measured by sensory testing methods. As used herein, “hard panned” coatings refer to non-particulate coatings where the coating provides a hard or crunchy or crispy bite as measured by sensory testing methods. The confectionery compositions may be tested by a fully-trained descriptive analysis panel using various methods, for example, the analysis may be conducted using the Spectrum™ method. This method incorporates a trained panel of individuals who measure confectionery compositions for several characteristics, providing a rating for each characteristic. The hardness of the coating may be measured on any scale desired. For example, hardness may be on a ten point scale from 1-10, where a rating of 1 is the softest and a rating of 10 is the hardest. Typically, soft panned coatings have a hardness rating below the rating of hard panned coatings. For example, in one embodiment, a soft panned coated product may have a hardness sensory rating of about 3-4, while hard panned coated product may have a hardness sensory rating of about 7-8.

As used herein, the terms “surround,” “surrounding,” “at least partially surrounding”, and the like are not limited to encircling. These terms may refer to enclosing or confining on all sides, encircling or enveloping, and are not limited to symmetrical or identical thicknesses for a region in a center-fill confectionery product.

As used herein, the term “substantially covers” refers to coating compositions that cover more than 50% of the surface area of a confectionery base. In other embodiments, “substantially covers” may refer to coverage that is more than 55%, more than 60%, more than 65%, more than 70%, more than 75%, more than 80%, more than 85%, more than 90%, more than 95%, more than 98%, and more than 99% of the surface are of a confectionery base.

Encapsulating material for encapsulating the encapsulated ingredient includes any one or more water soluble or water insoluble polymers, co-polymers, or other materials capable of forming a coating, shell, or film as a protective barrier or layer around one or more ingredients and/or capable of forming a matrix with the one or more ingredients. In some embodiments, the encapsulating material may completely surround, coat, cover, or enclose an ingredient. In other embodiments, the encapsulating material may only partially surround, coat, cover, or enclose an ingredient.

### Particulate Coating Composition

In some embodiments a particulate coating is provided. The particulate coating may include an acidic coating. Such an acidic coating may include food acids such as, but not limited to acetic acid, adipic acid, ascorbic acid, butyric acid, citric acid, formic acid, fumaric acid, glyconic acid, lactic acid, phosphoric acid, malic acid, oxalic acid, succinic acid, tartaric acid and combinations thereof. In some embodiments, the acidic coating can include an acid blend including two or more acids such as an acid blend of lactic acid, tartaric acid, and/or fumaric acid. One advantage of an acid blend is that it provides a significantly more tart or sour perception to a consumer as compared to an equivalent amount of citric acid.

In some embodiments a particulate coating is provided which may include at least one encapsulated ingredient. In other embodiments, the encapsulated ingredient can include an acid blend or two or more food acids. The encapsulated two or more food acids can include an acid blend where the acids are blended and then encapsulated together or the acid blend can include a blend of two or more acids that have been individually encapsulated. The particulate coating may be applied to the surface of the non-particulate coated confectionery composition.

The acid blend preferably includes lactic acid, which may also be present as calcium lactate or a blend of lactic acid with calcium lactate. Also included in the acid blend are tartaric acid and fumaric acid. The acid blend provides a more intense sour perception than an equivalent amount of citric acid. If desired, citric acid and other components may also be included in the acid blend. Each of the acid components may be present in any amount to provide the desired taste. For example, lactic acid may be present in an amount from about 50% to about 65%, or more specifically from about 51% to about 64%, or from about 52% to about 63%, or from about 53% to about 62%, or from about 54% to about 61% or about 55% to about 60% by weight of the acid blend, tartaric acid may be present in an amount from about 30% to about 45%, or more specifically from about 31% to about 44%, or from about 32% to about 43%, or from about 33% to about 42%, or from about 34% to about 41%, or from about 35 to about 40%, by weight of the acid blend, and fumaric acid may be present in an amount from about 1% to about 10%, or more specifically from about 2% to about 6%, or from about 2% to a bout 9%, or from about 3% to about 8%, or from about 4%, or about 7%, or from about 5%, or about 6%, by weight of the acid blend.

In some embodiments, an acid blend may be sized to a particular size for use in a particulate coating. For example, in some embodiments, an acid blend may have a particle size of from about 25 to about 710 microns, such as, for example, 710, 420, 250, 200, 100, 60, 50 or 25 microns. In some embodiments, the acid blend may have an average particle size from about 25 to about 710 microns, such as, for example, 710, 420, 250, 200, 100, 60, 50 or 25 microns. In some embodiments, the acid blend has a maximum particle size from about 25 to about 710 microns, such as, for example, 710, 420, 250, 200, 100, 60, 50 or 25 microns. The particular particle size selected will depend on the characteristics of the acid blend and/or the confectionery composition and as such, other sizes are possible in other embodiments. For example, acid blends and/or confectionery compositions with smooth, less crunchy textures require smaller particles sizes (below 25 microns) while in other examples, acid blends and/or confectionery compositions with rough or crunchy textures require larger particle sizes (above 250 microns). Also, in some embodiments, particles below a certain size (e.g., 25 microns) may be removed. In some embodiments, the particle size distribution may have a narrow range resulting in a sharp distribution. In some embodiments, the particle size distribution may have a wide range resulting in a smooth distribution.

The acid blend may be combined with sugars, polyols, or combinations of sugars and polyols to provide the acidic particulate coating. The acid blend may be present in the particulate coating in any desired amount, specifically from about 5% to about 20% by weight of the coating, more specifically from about 7% to about 18%, from about 9% to about 16%, from about 11% to about 14%, or about 10% by weight of the particulate coating. The sugar/polyol component may also be used in any desired amount to provide a 100% total weight in combination with the acid blend. Specifically, sugar/polyol may be used in an amount from about 85% to about 90% by weight of the acidic particulate coating. Additionally, the sugar/polyol component may be provided in any suitable particle size and/or particle size distribution to create a desired texture. The particulate coating may optionally include an adhesive syrup to hold the composition together and/or bind the particulate coating to the surface of the confectionery piece or to the non-particulate coating.

The particulate coating composition may include any conventional ingredient such as, but not limited to, salts, sweeteners, flavors, sensates, functional ingredients, and food acids including two or more food acids. In some embodiments, the particulate coating composition may be in particulate form, crystalline form, or amorphous form. In some embodiments, the particulate coating composition may be continuous or discontinuous. In some embodiments, the particulate coating may completely surround, coat, cover, or enclose a confectionery base. In other embodiments, the particulate coating may only partially surround, coat, cover, or enclose a confectionery base. The confectionery base may optionally be coated with a first non-particulate coating prior to being coated with a second particulate coating.

The selection of the form of the particulate coating composition may depend on the desired texture of the confectionery composition.

In some embodiments, the particulate coating composition may include one or more sweeteners, and/or one or more flavors, and/or one or more sensates, and/or one or more salts, and/or one or more functional ingredients, and/or one or more food acids. In some embodiments, the one or more sweeteners, and/or one or more flavors, and/or one or more sensates, and/or one or more functional ingredients, and/or one or more food acids may be encapsulated, unencapsulated (or “free”) or a combination of encapsulated and unencapsulated.

In still other embodiments, the particulate coating composition may be in particulate form and may include one or more sweeteners, and/or one or more flavors, and/or one or more sensates, and/or one or more salts, and/or one or more functional ingredients, and/or one or more food acid materials with similar particle sizes such that if they are mixed together, they form a homogeneous blend.

In embodiments where the particulate coating may be in particulate form, the food acid or flavor or sensate or sweetener or salt or functional ingredient materials may be present in an amount from about 0.05% by weight to about 20% by weight, specifically from about 0.1% to about 18%, or from about 1% to about 16%, or from about 5% by weight to about 15% by weight of the coating composition.

In some embodiments, the particulate coating may also include a saccharide. Saccharides can include sugar saccharides or polyol saccharides or combinations of sugar saccharides and polyol saccharides. Suitable saccharides may include, but are not limited to, mono-saccharides, di-saccharides and poly-saccharides such as but not limited to, sucrose (sugar), dextrose, maltose, dextrin, xylose, ribose, glucose, mannose, galactose, sucromalt, fructose (levulose), invert sugar, corn syrups, maltodextrins, fructo oligo saccharide syrups, partially hydrolyzed starch, corn syrup solids, polydextrose, soluble fibers, insoluble fibers, and mixtures thereof.

Suitable polyol saccharides may include, but are not limited to sugar alcohols (or polyols) such as, but not limited to, sorbitol, xylitol, mannitol, galactitol, maltitol, hydrogenated isomaltulose (ISOMALT), lactitol, erythritol, hydrogenated starch hydrolysates, maltitol syrups, and mixtures thereof.

Suitable hydrogenated starch hydrolysates include those disclosed in U.S. Pat. No. 4,279,931 and various hydrogenated glucose syrups and/or powders which contain sorbitol, hydrogenated disaccharides, hydrogenated higher polysaccharides, or mixtures thereof. Hydrogenated starch hydrolysates are primarily prepared by the controlled catalytic hydrogenation of corn syrups. The resulting hydrogenated starch hydrolysates are mixtures of monomeric, dimeric, and polymeric saccharides. The ratios of these different saccharides give different hydrogenated starch hydrolysates different properties. Mixtures of hydrogenated starch hydrolysates, such as LYCASIN®, a commercially available product manufactured by Roquette Freres of France, and HYSTAR®, a commercially available product manufactured by SPI Polyols, Inc. of New Castle, Del., are also useful.

In some embodiments, the particulate coating with the sugar saccharides and/or polyol saccharides may be particulate form. In some embodiments, the coating composition may be in particulate form and may include encapsulated ingredients as described below.

In embodiments where the confectionery product includes a first non-particulate coating composition in crystalline or amorphous form, the coating may be created by any conventional method known in the coating art. Such methods may include, but are not limited to, hard panning, soft panning, enrobing, spray coating, lamination, co-extrusion, multiple-extrusion, drum sanding, thin film depositing, and the like. Preferably, the confectionery composition is coated with a non-particulate coating prior to being coated with the particulate coating. As with the particulate coating compositions, crystalline or amorphous non-particulate coating compositions may include sweeteners and food acids and may be created to provide sour taste intensities equivalent to 0.2% by weight solution of citric and/or a sour taste intensity of at least 4 on a scale from 0 to 10.

In some embodiments, the dual-coating composition may be included in the confectionery composition in amounts from about 1% by weight of the total composition to about 75% of the total composition. In some embodiments, the dual-coating composition may be included in the dual-coated center-filled composition in amounts from about 5% by weight of the total composition to about 15% by weight of the total composition. In other embodiments, the dual-coating composition may be included in amounts of from about 5% to about 70%, or from about 10% to about 65%, or from about 15% to about 60%, or from about 20% to about 55%, or from about 25% to about 50%, or from about 30% to about 45%, or from about 35% to about 40% by weight of the total composition.

### Encapsulation

In some embodiments, one or more ingredients may be encapsulated with an encapsulating material. In some embodiments, partially or completely encapsulating an ingredient used in an confectionery composition with an encapsulating material may modify the release of the ingredient during consumption of the confectionery composition, thereby modifying when the ingredient becomes available inside the consumer's mouth, throat, and/or stomach, available to react or mix with another ingredient, and/or available to provide some sensory experience and/or functional or therapeutic benefit. When the ingredient is water soluble or at least partially water soluble, the modification may be a delayed release. In other embodiments, the modification may be an accelerated release.

In some embodiments, partially or completely encapsulating an ingredient used in a confectionery composition with an encapsulating material may stabilize the ingredient against moisture absorption and/or moisture migration.

In some embodiments, a material used to encapsulate an ingredient may include water insoluble polymers, co-polymers, or other materials capable of forming a matrix, solid coating, or film as a protective barrier with or for the ingredient. In some embodiments, the encapsulating material may completely surround, coat, cover, or enclose an ingredient. In other embodiments, the encapsulating material may only partially surround, coat, cover, or enclose an ingredient. Different encapsulating materials may provide different release rates or release profiles or protective barriers for the encapsulated ingredient. In some embodiments, encapsulating material may include one or more of the following: polyvinyl acetate, polyethylene, crosslinked polyvinyl pyrrolidone, polymethylmethacrylate, polylactidacid, polyhydroxyalkanoates, ethylcellulose, polyvinyl acetatephthalate, polyethylene glycol esters, methacrylicacid-co-methylmethacrylate, ethylene-vinylacetate (EVA) copolymer, and the like, and combinations thereof.

In some embodiments, the encapsulating material may include fats, waxes, gelatins, hydrocolloids, or oils and may include one or more of the following: hydrogenated cottonseed oil, hydrogenated palm kernel oil, hydrogenated corn oil, hydrogenated soy bean oil, cocoa butter, hydrogenated vegetable oil, bees wax, and the like, and combinations thereof.

In some embodiments, the encapsulating material may have a melting point from about 45° C. to about 70° C. In still other embodiments, the encapsulating material may have a melting point from about 50° C. to about 65° C.

In some embodiments, the encapsulating material may be water soluble or water miscible. In such embodiments, the encapsulating material may include, but is not limited to, hydrocolloids such as starch, gum arabic, maltodextrin, dextrins, and the like, and combinations thereof.

In some embodiments, an ingredient may be pre-treated prior to encapsulation with an encapsulating material. For example, an ingredient may be pre-treated with a “pre-treatment material” that is not miscible with the ingredient or is at least less miscible with the ingredient relative to the ingredient's miscibility with the encapsulating material.

In some embodiments, the same or different encapsulating material may be used to individually encapsulate different ingredients in the same confectionery composition. In some embodiments, the same or different methods of encapsulation may be used to individually encapsulate different ingredients in the same confectionery composition.

For example, aspartame may be encapsulated by polyvinyl acetate by using an extrusion method. Separately ace-k may be encapsulated by polyvinyl acetate by using an extrusion method. Both encapsulations may be used as ingredients in the same confectionery compositions. For addition examples, see U.S. patent application Ser. No. 11/134,367 entitled “A Delivery System for Active Components as Part of an edible Composition” and filed May 23, 2005, the entire contents of which are incorporated herein by reference for all purposes.

In other embodiments, malic acid may be encapsulated by hydrogenated cottonseed oil using a spray chilling method and tartaric acid may be encapsulated by hydrogenated cottonseed oil using a spray chilling method. Both encapsulations may be used in the same confectionery composition.

In some embodiments, different encapsulation materials may be used to individually encapsulate different ingredients used in the same confectionery composition. For example, aspartame may be encapsulated by polyvinyl acetate using an extrusion method. Another encapsulation may include ace-k encapsulated by EVA using an extrusion method. Both encapsulations may be used as ingredients in the same confectionery compositions. Examples of encapsulated ingredients using different encapsulating materials may be found in U.S. Patent Application Ser. No. 60/655,894 filed Feb. 25, 2005, which was converted to non-provisional application Ser. No. 11/302,255, and published as U.S. Publication No. 20060193896, and entitled “Process for Manufacturing a Delivery System for Active Components as Part of an Edible Composition,” the entire contents of which are incorporated herein by reference for all purposes.

In some embodiments two or more food acids may be encapsulated. For example, citric acid may be encapsulated in hydrogenated soy bean oil using a spray chilling method while lactic acid may be encapsulated in gum arabic using a spray drying method. Both encapsulations may then be used in the same confectionery composition.

In some embodiments, different ingredients may be blended and then encapsulated together. For example, aspartame may be mixed with ace-K and then encapsulated together in polyvinyl acetate by an extrusion method. In other embodiments, malic acid may be blended with tartaric acid and then encapsulated together in hydrogenated vegetable oil by a spray chilling method.

### Methods of Encapsulation

There are many ways to encapsulate one or more ingredients with an encapsulating material. For example, in some embodiments, a sigma blade or Banbury™ type mixer may be used. In other embodiments, an extruder or other type of continuous mixer may be used. In some embodiments, spray coating, spray chilling, absorption, adsorption, inclusion complexing (e.g., creating a flavor/cyclodextrin complex, forming a glassy matrix, etc.), coacervation, fluidized bed coating, melt spinning, or other process may be used to encapsulate an ingredient with an encapsulating material.

Examples of encapsulation of ingredients may be found in U.S. patent application Ser. No. 11/302,255, and published as U.S. Publication No. 20060193896, entitled “Process for Manufacturing a Delivery System for Active Components as Part of an Edible Composition,” the entire contents of which are incorporated herein by reference for all purposes. Other examples of encapsulation of ingredients may be found in U.S. patent application Ser. No. 10/955,255 filed Sep. 30, 2004, and entitled “Encapsulated Compositions and Methods of Preparation,” the entire contents of which are incorporated herein by reference for all purposes. Further examples of encapsulation of ingredients may be found in U.S. patent application Ser. No. 10/955,149 filed Sep. 30, 2004, and entitled “Thermally Stable High Tensile Strength Encapsulation Compositions for Actives,” the entire contents of which are incorporated herein by reference for all purposes. Still further examples of encapsulation of ingredients may be found in U.S. patent application Ser. No. 11/052,672 filed Feb. 7, 2005, and entitled “Stable Tooth Whitening Gum with Reactive Components,” the entire contents of which are incorporated herein by reference for all purposes. Further encapsulation techniques and resulting delivery systems may be found in U.S. Pat. Nos. 6,770,308, 6,759,066, 6,692,778, 6,592,912, 6,586,023, 6,555,145, 6,479,071, 6,472,000, 6,444,241, 6,365,209, 6,174,514, 5,693,334, 4,711,784, 4,816,265, and 4,384,004, the contents of all of which are incorporated herein by reference for all purposes.

In some embodiments, an encapsulation may be sized to a particular size for use as an ingredient in a confectionery composition. For example, in some embodiments, an ingredient may have a particle size of from about 25 to about 710 microns. In some embodiments, the encapsulation may have an average particle size from about 25 to about 710 microns, such as, for example, 710, 420, 250, 200, 100, 60, 50 or 25 microns. In some embodiments, the encapsulation has a maximum particle size from about 25 to about 710 microns, such as, for example, 710, 420, 250, 200, 100, 60, 50 or 25 microns. The ultimate particle size will depend on the characteristics of the encapsulation and/or the confectionery composition and as such, other sizes are possible in other embodiments. For example, encapsulations and/or confectionery compositions with smooth, creamy textures require smaller particles sizes (below 25 microns) while in other examples, encapsulations and/or confectionery compositions with rough textures require larger particle sizes (above 250 microns). Also, in some embodiments, particles below a certain size (e.g., 25 microns) may be removed. In some embodiments, the particle size distribution may have a narrow range resulting in a sharp distribution. In some embodiments, the particle size distribution may have a wide range resulting in a smooth distribution.

### Ingredients

Additional additives, such as warming agents, cooling agents, tingling agents, flavors, sweeteners, sour tastes, bitter tastes, salty tastes, surfactants, breath freshening agents, anti-microbial agents, anti-bacterial agents, anti-calculus agents, antiplaque agents, fluoride compounds, remineralization agents, pharmaceuticals, micronutrients, throat care actives, tooth whitening agents, energy boosting agents, concentration boosting agents, appetite suppressants, colors and other actives may also be included in any or all portions or regions of the confectionery composition. Such ingredients may be used in amounts sufficient to achieve their intended effects.

Any of the ingredients discussed herein may be added to any region of the confectionery composition in their modified release or encapsulated form and/or without modified release or unencapsulated form (sometimes referred to as “free” ingredients).

### Sweeteners:

Sweeteners may include saccharides such as sugar bulk sweeteners, sugarless bulk sweeteners, or the like, high intensity sweeteners, or mixtures thereof. Bulk sweeteners generally are present in amounts of about 5% to about 99% by weight of the confectionery base composition. Suitable sugar bulk sweeteners generally include mono-saccharides, di-saccharides and poly-saccharides such as but not limited to, sucrose (sugar), dextrose, maltose, dextrin, xylose, ribose, glucose, mannose, galactose, fructose (levulose), invert sugar, corn syrups, maltodextrins, fructo oligo saccharide syrups, partially hydrolyzed starch, corn syrup solids and mixtures thereof.

Suitable sugarless bulk sweeteners include sugar alcohols (or polyols) such as, but not limited to, sorbitol, xylitol, mannitol, galactitol, maltitol, hydrogenated isomaltulose (ISOMALT), lactitol, erythritol, hydrogenated starch hydrolysates, maltitol syrups, and mixtures thereof

Suitable hydrogenated starch hydrolysates include those disclosed in U.S. Pat. No. 4,279,931 and various hydrogenated glucose syrups and/or powders which contain sorbitol, hydrogenated disaccharides, hydrogenated higher polysaccharides, or mixtures thereof. Hydrogenated starch hydrolysates are primarily prepared by the controlled catalytic hydrogenation of corn syrups. The resulting hydrogenated starch hydrolysates are mixtures of monomeric, dimeric, and polymeric saccharides. The ratios of these different saccharides give different hydrogenated starch hydrolysates different properties. Mixtures of hydrogenated starch hydrolysates, such as LYCASIN®, a commercially available product manufactured by Roquette Freres of France, and HYSTAR®, a commercially available product manufactured by SPI Polyols, Inc. of New Castle, Del., are also useful.

In some embodiments, high-intensity sweeteners also may be included as sweetening agents in the composition. Without being limited to particular sweeteners, representative categories and examples include:

(a) water-soluble sweetening agents such as dihydrochalcones, monellin, stevia, steviosides, rebaudioside A, glycyrrhizin, dihydroflavenol, and sugar alcohols such as sorbitol, mannitol, maltitol, xylitol, erythritol and L-aminodicarboxylic acid aminoalkenoic acid ester amides, such as those disclosed in U.S. Pat. No. 4,619,834, which disclosure is incorporated herein by reference, and mixtures thereof;

(b) water-soluble artificial sweeteners such as soluble saccharin salts, i.e., sodium or calcium saccharin salts, cyclamate salts, the sodium, ammonium or calcium salt of 3,4-dihydro-6-methyl-1,2,3-oxathiazine-4-one-2,2-dioxide, the potassium salt of 3,4-dihydro-6-methyl-1,2,3-oxathiazine-4-one-2,2-dioxide (Acesulfame-K), the free acid form of saccharin, and mixtures thereof;

(c) dipeptide based sweeteners, such as L-aspartic acid derived sweeteners, such as L-aspartyl-L-phenylalanine methyl ester (Aspartame) and materials described in U.S. Pat. No. 3,492,131, L-alphaaspartyl-N-(2,2,4,4-tetramethyl-3-thietanyl)-D-alaninamide hydrate (Alitame), N—[N-(3,3-dimethylbutyl)-L-aspartyl]-L-phenylalanine 1-methyl ester (Neotame), methyl esters of L-aspartyl-L-phenylglycerine and L-aspartyl-L-2,5-dihydrophenyl-glycine, L-aspartyl-2,5-dihydro-L-phenylalanine; L-aspartyl-L-(1-cyclohexen)-alanine, and mixtures thereof;

(d) water-soluble sweeteners derived from naturally occurring water-soluble sweeteners, such as chlorinated derivatives of ordinary sugar (sucrose), e.g., chlorodeoxysugar derivatives such as derivatives of chlorodeoxysucrose or chlorodeoxygalactosucrose, known, for example, under the product designation of Sucralose; examples of chlorodeoxysucrose and chlorodeoxygalactosucrose derivatives include but are not limited to: 1-chloro-1′-deoxysucrose; 4-chloro-4-deoxy-alpha-D-galactopyranosyl-alpha-D-fructofuranoside, or 4-chloro-4-deoxygalactosucrose; 4-chloro-4-deoxy-alpha-D-galactopyranosyl-1-chloro-1-deoxy-beta-D-fructo-f uranoside, or 4,1′-dichloro-4,1′-dideoxygalactosucrose; 1′,6′-dichloro1′,6′-dideoxysucrose; 4-chloro-4-deoxy-alpha-D-galactopyranosyl-1,6-dichloro-1,6-dideoxy-beta-D-fructofuranoside, or 4,1′,6′-trichloro-4,1′,6′-trideoxygalactosucrose; 4,6-dichloro-4,6-dideoxy-alpha-D-galactopyranosyl-6-chloro-6-deoxy-beta-D-fructofuranoside, or 4,6,6′-trichloro-4,6,6′-1421-269 trideoxygalactosucrose; 6,1′,6′-trichloro-6,1′,6′-trideoxysucrose; 4,6-dichloro-4,6-dideoxy-alpha-D-galacto-pyranosyl-1,6-dichloro-1,6-dideoxy-beta-D-fructofuranoside, or 4,6,1′,6′-tetrachloro-4,6,1′,6′-tetradeoxygalacto-sucrose; and 4,6,1′,6′-tetradeoxy-sucrose, and mixtures thereof;

(e) protein based sweeteners such as miraculin, extracts and derivatives of extracts of Synseplum dulcificum, mabinlin, curculin, monellin, brazzein, pentadin, extracts and derivatives of extracts of Pentadiplandra brazzeana, thaumatin, thaumaoccous danielli (Thaumatin I and II) and talin;

(f) the sweetener monatin (2-hydroxy-2-(indol-3-ylmethyl)-4-aminoglutaric acid) and its derivatives; and

(g) the sweetener Lo han guo (sometimes also referred to as “Lo han kuo” or “Lo han quo”).

In some embodiments, hydrophobic sweeteners such as those disclosed in U.S. Pat. No. 7,025,999, which disclosure is incorporated herein by reference, and mixtures thereof, may be used.

In some embodiments wherein a high intensity sweetener is included, the sweetener may be sucralose, saccharin salts, acesulfame potassium, aspartame, thaumatin, monatin (2-hydroxy-2-(indol-3-ylmethyl)-4-amino glutaric acid), neotame, alitame, and combinations thereof.

The intense sweetening agents may be used in many distinct physical forms well-known in the art to provide an initial burst of sweetness and/or a prolonged sensation of sweetness. Without being limited thereto, such physical forms include free forms, spray dried forms, powdered forms, beaded forms, encapsulated forms, and mixtures thereof. In one embodiment, the sweetener is a high intensity sweetener such as aspartame, sucralose, and acesulfame potassium (e.g., Ace-K).

In general, an effective amount of intense sweetener may be utilized to provide the level of sweetness desired, and this amount may vary with the sweetener selected. The intense sweetener may be present in amounts from about 0.001% to about 3%, by weight of the composition, depending upon the sweetener or combination of sweeteners used. The exact range of amounts for each type of sweetener may be selected by those skilled in the art.

In general, an effective amount of intense sweetener may be utilized to provide the level of sweetness desired, and this amount may vary with the sweetener selected. The intense sweetener may be present in amounts from about 0.001% to about 3%, by weight of the total composition, depending upon the sweetener or combination of sweeteners used. The exact range of amounts for each type of sweetener may be selected by those skilled in the art.

### Flavors and Flavor Potentiators:

In some embodiments, flavorants may include those flavors known to the skilled artisan, such as natural and artificial flavors. These flavorings may be chosen from synthetic flavor oils and flavoring aromatics and/or oils, oleoresins and extracts derived from plants, leaves, flowers, fruits, and so forth, and combinations thereof. Generally any flavoring or food additive such as those described in Chemicals Used in Food Processing, publication 1274, pages 63-258, by the National Academy of Sciences, may be used. This publication is incorporated herein by reference. These may include natural as well as synthetic flavors.

Nonlimiting representative flavor oils include spearmint oil, cinnamon oil, oil of wintergreen (methyl salicylate), peppermint oil, Japanese mint oil, clove oil, bay oil, anise oil, eucalyptus oil, thyme oil, cedar leaf oil, oil of nutmeg, allspice, oil of sage, mace, oil of bitter almonds, and cassia oil. Also useful flavorings are artificial, natural and synthetic fruit flavors such as vanilla, and citrus oils including lemon, orange, lime, grapefruit, yazu, sudachi, and fruit essences including apple, pear, peach, grape, blueberry, strawberry, raspberry, cherry, plum, pineapple, apricot, banana, melon, apricot, ume, cherry, raspberry, blackberry, tropical fruit, mango, mangosteen, pomegranate, papaya and so forth. Other potential flavors whose release profiles may be managed include a milk flavor, a butter flavor, a cheese flavor, a cream flavor, and a yoghurt flavor; a vanilla flavor; tea or coffee flavors, such as a green tea flavor, a oolong tea flavor, a tea flavor, a cocoa flavor, a chocolate flavor, and a coffee flavor; mint flavors, such as a peppermint flavor, a spearmint flavor, and a Japanese mint flavor; spicy flavors, such as an asafetida flavor, an ajowan flavor, an anise flavor, an angelica flavor, a fennel flavor, an allspice flavor, a cinnamon flavor, a chamomile flavor, a mustard flavor, a cardamom flavor, a caraway flavor, a cumin flavor, a clove flavor, a pepper flavor, a coriander flavor, a sassafras flavor, a savory flavor, a Zanthoxyli Fructus flavor, a perilla flavor, a juniper berry flavor, a ginger flavor, a star anise flavor, a horseradish flavor, a thyme flavor, a tarragon flavor, a dill flavor, a capsicum flavor, a nutmeg flavor, a basil flavor, a marjoram flavor, a rosemary flavor, a bayleaf flavor, and a wasabi (Japanese horseradish) flavor; alcoholic flavors, such as a wine flavor, a whisky flavor, a brandy flavor, a rum flavor, a gin flavor, and a liqueur flavor; floral flavors; and vegetable flavors, such as an onion flavor, a garlic flavor, a cabbage flavor, a carrot flavor, a celery flavor, mushroom flavor, and a tomato flavor. Commonly used flavors include mints such as peppermint, menthol, spearmint, artificial vanilla, cinnamon derivatives, and various fruit flavors, whether employed individually or in admixture. Flavors may also provide breath freshening properties, particularly the mint flavors when used in combination with the cooling agents, described herein below. In some embodiments, the composition may include fruit juices.

In some embodiments, flavoring agents are used at levels that provide a perceptible sensory experience, i.e. at or above their threshold levels. In other embodiments, flavoring agents are used at levels below their threshold levels such that they do not provide an independent perceptible sensory experience. At subthreshold levels, the flavoring agents may provide an ancillary benefit such as flavor enhancement or potentiation.

In some embodiments, the flavoring agents may be used in many distinct physical forms. Without being limited thereto, such physical forms include liquid and/or dried form. IN some embodiments, the flavoring agents can be in free (unencapsulated) forms, spray dried forms, powdered forms, beaded forms, encapsulated forms, and mixtures thereof. When employed in a spray dried form, suitable drying means such as spray drying the liquid may be used. Alternatively, the flavoring agent may be absorbed onto water soluble materials, such as cellulose, starch, sugar, maltodextrin, gum arabic and so forth or may be encapsulated. In still other embodiments, the flavoring agent may be adsorbed onto silicas, zeolites, and the like.

In some embodiments, potentiators may be included. Potentiators may consist of materials that may intensify, supplement, modify or enhance the taste and/or aroma perception of an original material without introducing a characteristic taste and/or aroma perception of their own. In some embodiments, potentiators designed to intensify, supplement, modify, or enhance the perception of flavor, sweetness, tartness, umami, kokumi, saltiness and combinations thereof may be included.

In some embodiments, examples of suitable potentiators, also known as taste potentiators include, but are not limited to, neohesperidin dihydrochalcone, chlorogenic acid, alapyridaine, cynarin, miraculin, glupyridaine, pyridinium-betain compounds, glutamates, such as monosodium glutamate and monopotassium glutamate, neotame, thaumatin, tagatose, trehalose, salts, such as sodium chloride, monoammonium glycyrrhizinate, vanilla extract (in ethyl alcohol), sugar acids, potassium chloride, sodium acid sulfate, hydrolyzed vegetable proteins, hydrolyzed animal proteins, yeast extracts, adenosine monophosphate (AMP), glutathione, nucleotides, such as inosine monophosphate, disodium inosinate, xanthosine monophosphate, guanylate monophosphate, alapyridaine (N-(1-carboxyethyl)-6-(hydroxymethyl)pyridinium-3-ol inner salt, compositions comprising 5′-nucleotides such as those disclosed in US 2006/0078972 to Noordam et al, which is incorporated in its entirety herein by reference, sugar beet extract (alcoholic extract), sugarcane leaf essence (alcoholic Extract), curculin, strogin, mabinlin, gymnemic acid, hydroxybenzoic acids, 3-hydrobenzoic acid, 2,4-dihydrobenzoic acid, citrus aurantium, vanilla oleoresin, sugarcane leaf essence, maltol, ethyl maltol, vanillin, licorice glycyrrhizinates, compounds that respond to G-protein coupled receptors (T2Rs and T1Rs) and taste potentiator compositions that impart kokumi, as disclosed in U.S. Pat. No. 5,679,397 to Kuroda et al., which is incorporated in its entirety herein by reference. “Kokumi” refers to materials that impart “mouthfulness” and “good body”.

Illustrations of the encapsulation of flavors as well as other ingredients may be found in the examples provided herein. Typically, encapsulation of an ingredient will result in a change in the release of the predominant amount of the ingredient during consumption of a confectionery composition that includes the encapsulated ingredient (e.g., as part of a delivery system added as a dusting or sanding ingredient to the confectionery composition). In some embodiments, the change in release rate involves an accelerated or faster or more immediate release while in some embodiments, the change in release rate involves a delayed release. In some embodiments, the release profile of the dusting or sanding ingredient (e.g., the flavor, sweetener, etc.) may be managed by managing various characteristics of the dusting or sanding ingredient, delivery system containing the dusting or sanding ingredient, and/or the confectionery composition containing the delivery system and/or how the delivery system is made. For example, characteristics might include one or more of the following: tensile strength of the delivery system, water solubility of the dusting or sanding ingredient, water solubility of the encapsulating material, water solubility of the delivery system, ratio of dusting or sanding ingredient to encapsulating material in the delivery system, average or maximum particle size of dusting or sanding ingredient, average or maximum particle size of ground delivery system, the amount of the dusting or sanding ingredient or the delivery system in the confectionery composition, ratio of different polymers used to encapsulate one or more dusting or sanding ingredient, hydrophobicity of one or more polymers used to encapsulate one or more dusting or sanding ingredient, hydrophobicity of the delivery system, the type or amount of coating on the delivery system, the type or amount of coating on a dusting or sanding ingredient prior to the dusting or sanding ingredient being encapsulated, etc.

### Sensates:

The composition may further include sensates. Sensate compounds may include cooling agents, warming agents, tingling agents, effervescent agents, and combinations thereof. A variety of well known cooling agents may be employed. For example, useful cooling agents may include xylitol, erythritol, dextrose, sorbitol, menthane, menthone, ketals, menthone ketals, menthone glycerol ketals, substituted p-menthanes, acyclic carboxamides, mono menthyl glutarate, substituted cyclohexanamides, substituted cyclohexane carboxamides, substituted ureas and sulfonamides, substituted menthanols, hydroxymethyl and hydroxymethyl derivatives of p-menthane, 2-mercapto-cyclo-decanone, hydroxycarboxylic acids with 2-6 carbon atoms, cyclohexanamides, menthyl acetate, menthyl salicylate, N,2,3-trimethyl-2-isopropyl butanamide (WS-23), N-ethyl-p-menthane-3-carboxamide (WS-3), isopulegol, 3-(1-menthoxy)propane-1,2-diol, 3-(1-menthoxy)-2-methylpropane-1,2-diol, p-menthane-2,3-diol, p-menthane-3,8-diol, 6-isopropyl-9-methyl-1,4-dioxaspiro[4,5]decane-2-methanol, menthyl succinate and its alkaline earth metal salts, trimethylcyclohexanol, N-ethyl-2-isopropyl-5-methylcyclohexanecarboxamide, Japanese mint oil, peppermint oil, 3-(1-menthoxy)ethan-1-ol, 3-(1-menthoxy)propan-1-ol, 3-(1-menthoxy)butan-1-ol, 1-menthylacetic acid N-ethylamide, 1-menthyl-4-hydroxypentanoate, 1-menthyl-3-hydroxybutyrate, N,2,3-trimethyl-2-(1-methylethyl)-butanamide, n-ethyl-t-2-c-6 nonadienamide, N,N-dimethyl menthyl succinamide, substituted p-menthanes, substituted p-menthane-carboxamides, 2-isopropanyl-5-methylcyclohexanol (from Hisamitsu Pharmaceuticals, hereinafter “isopregol”); menthone glycerol ketals (FEMA 3807, tradename FRESCOLAT® type MGA); 3-1-menthoxypropane-1,2-diol (from Takasago, FEMA 3784); and menthyl lactate; (from Haarman & Reimer, FEMA 3748, tradename FRESCOLAT® type ML), WS-30, WS-5, WS-14, Eucalyptus extract (p-Mehtha-3,8-Diol), Menthol (its natural or synthetic derivatives), Menthol PG carbonate, Menthol EG carbonate, Menthol glyceryl ether, N-tertbutyl-p-menthane-3-carboxamide, P-menthane-3-carboxylic acid glycerol ester, Methyl-2-isopropyl-bicyclo (2.2.1), Heptane-2-carboxamide; and Menthol methyl ether, and menthyl pyrrolidone carboxylate among others. These and other suitable cooling agents are further described in the following U.S. patents, all of which are incorporated in their entirety by reference hereto: U.S. Pat. Nos. 4,230,688; 4,032,661; 4,459,425; 4,136,163; 5,266,592; 6,627,233.

In some embodiments, warming components may be selected from a wide variety of compounds known to provide the sensory signal of warming to the user. These compounds offer the perceived sensation of warmth, particularly in the oral cavity, and often enhance the perception of flavors, sweeteners and other organoleptic components. In some embodiments, useful warming compounds may include vanillyl alcohol n-butylether (TK-1000) supplied by Takasago Perfumery Company Limited, Tokyo, Japan, vanillyl alcohol n-propylether, vanillyl alcohol isopropylether, vanillyl alcohol isobutylether, vanillyl alcohol n-aminoether, vanillyl alcohol isoamyleather, vanillyl alcohol n-hexyleather, vanillyl alcohol methylether, vanillyl alcohol ethylether, gingerol, shogaol, paradol, zingerone, capsaicin, dihydrocapsaicin, nordihydrocapsaicin, homocapsaicin, homodihydrocapsaicin, ethanol, isopropyl alcohol, iso-amylalcohol, benzyl alcohol, glycerine, and combinations thereof.

In some embodiments, a tingling sensation may be provided. One such tingling sensation is provided by adding jambu oleoresin, or spilanthol to some examples. In some embodiments, alkylamides extracted from materials such as jambu or sanshool may be included. Additionally, in some embodiments, a sensation is created due to effervescence. Such effervescence is created by combining an alkaline material with an acidic material. In some embodiments, an alkaline material may include alkali metal carbonates, alkali metal bicarbonates, alkaline earth metal carbonates, alkaline earth metal bicarbonates and mixtures thereof. In some embodiments, an acidic material may include acetic acid, adipic acid, ascorbic acid, butyric acid, citric acid, formic acid, fumaric acid, glyconic acid, lactic acid, phosphoric acid, malic acid, oxalic acid, succinic acid, tartaric acid and combinations thereof. Examples of “tingling” type sensates may be found in U.S. Pat. No. 6,780,443, the entire contents of which are incorporated herein by reference for all purposes.

Sensate components may also be referred to as “trigeminal stimulants” such as those disclosed in U.S. Patent Application No. 2005/0202118, which is incorporated herein by reference. Trigeminal stimulants are defined as an orally consumed product or agent that stimulates the trigeminal nerve. Examples of cooling agents which are trigeminal stimulants include menthol, WS-3, N-substituted p-menthane carboxamide, acyclic carboxamides including WS-23, WS-5, WS-14, methyl succinate, and menthone glycerol ketals. Trigeminal stimulants may also include flavors, tingling agents, Jambu extract, vanillyl alkyl ethers, such as vanillyl n-butyl ether, spilanthol, Echinacea extract, Northern Prickly Ash extract, capsaicin, capsicum oleoresin, red pepper oleoresin, black pepper oleoresin, piperine, ginger oleoresin, gingerol, shoagol, cinnamon oleoresin, cassia oleoresin, cinnamic aldehyde, eugenol, cyclic acetal of vanillin and menthol glycerin ether, unsaturated amides, and combinations thereof. Other cooling compounds may include derivatives of 2,3-dimethyl-2-isopropylbutyric acid such as those disclosed in U.S. Pat. No. 7,030,273, which is incorporated herein by reference.

In addition to trigeminal nerve stimulants and cooling compounds, a cooling sensation may be provided by materials exhibiting a negative heat of solution including, but not limited to, dextrose and polyols such as xylitol, erythritol, isomalt, and sorbitol, and combinations thereof.

In some embodiments, sensate components are used at levels that provide a perceptible sensory experience i.e. at or above their threshold levels. In other embodiments, sensate components are used at levels below their threshold levels such that they do not provide an independent perceptible sensory experience. At subthreshold levels, the sensates may provide an ancillary benefit such as flavor or sweetness enhancement or potentiation.

### Functional Ingredients

Functional ingredients as discussed above and such as, but not limited to, medicaments, nutrients such as vitamins and minerals and the like, nutraceuticals such as phytochemicals and the like, breath freshening agents, antioxidants, oral care agents, probiotic materials, prebiotic materials, and throat care agents. Functional ingredients may be included in any region of the confectionery composition, including the confectionery base, the non-particulate coating layer, and/or the particulate coating layer.

### Acids

In some embodiments, the food acids are selected such that they provide a sour taste intensity of at least 4 on a scale from 0 to 10. Scales that may be used to measure sour taste have been developed by several sensory researchers. One example of a scale has been developed by Dr. Howard Moskowitz and is discussed in the journal article entitled Sourness of Acid Mixtures as published in The Journal of Experimental Psychology, April 1974; 102(4); 640-7 and in the journal article entitled Ration Scales of Acid Sourness as published in Perception and Psychophysics; 9:371-374, 1971.

Where a coating with a sour taste perception is desired, the coating composition may include food acids. It has been found that including food acids with hygroscopicities lower than citric acid in the coating will reduce the amount of water being pulled from the confectionery base and thus improve the keeping quality of the confection. Food acids with hygroscopicities lower than citric acid may include malic acid and lactic acid. Also, food acids with hygroscopicities lower than the hygroscopicity of the non-particulate coating may reduce moisture migration.

In some embodiments, a coating with a sour taste perception similar to the sour taste perception provided by citric acid is desired. The sour taste perception of an aqueous solution of 0.2% w/w of citric acid has been characterized as providing clean and refreshing tartness. In some embodiments, a coating with a sour taste perception similar to the sour taste perception of a 0.2% w/w solution of citric acid is created by using acids other than citric acid. In still other embodiments, a coating with a sour taste perception similar to the sour taste perception of a 0.2% w/w solution of citric acid is created with one or more food acids with hygroscopicities lower than citric acid.

In some embodiments, a coating with a sour taste intensity of at least 4 on a scale of 0 to 10 is desired. In still other embodiments, a coating with a sour taste intensity of at least 4 on a scale of 0 to 10 is created using one or more food acids with hygroscopicities less than citric acid.

In some embodiments the food acid may include, but is not limited to, acetic acid, adipic acid, ascorbic acid, butyric acid, citric acid, formic acid, fumaric acid, glyconic acid, lactic acid, phosphoric acid, malic acid, oxalic acid, succinic acid, tartaric acid, and combinations thereof. In some embodiments, the food acids may include lactic acid, tartaric acid, fumaric acid, malic acid, and combinations thereof. In other embodiments, the food acid materials are selected such that they provide a sour taste intensity equivalent to a 0.2% w/w solution of citric acid.

In other embodiments, the amount of acid used is determined by calculating the number of hydrogen ions released by a given acid or acid blend relative to the number of hydrogen ions released by a particular amount of citric acid. Adjustments may then be made in the amount of the acid(s) to provide the same number of released hydrogen ions that would be released by that particular amount of citric acid.

### Non-Particulate Coating Composition

In some embodiments, a non-particulate coating composition is provided at least partially surrounding the outer surface of the confectionery base. In some embodiments, the non-particulate coating may prevent moisture migration between the confectionery base and the particulate coating. The non-particulate coating may include a crystalline form of a sugar saccharide or polyol saccharide. In some embodiments, the non-particulate coating is formed when sugar saccharides or polyol saccharides in the confectionery base crystallize at the surface of the confectionery base. The non-particulate coating may include acids, colors, and flavors.

The multiple regions of the confectionery product can be modified to achieve desired visual effects. For example, one color may be included in the non-particulate coating composition while different colors are included in the confectionery base and the particulate coating. In some embodiments the opacity of the regions may differ to provide other visual effects. For example, the confectionery base may be opaque while the non-particulate coating may be transparent and the particulate coating may be translucent. Different opacities may be combined with the same or different colors for still more visual effects.

### Confectionery Compositions

In some embodiments, the confectionery base may include chewable gummy candy or “gummi” confections. The confectionery base may be a cooked starch gummy base, including a generic starch gelled composition. Other contemplated confectionery base forms are hard or soft candies such as, but not limited to, gum drops, licorice, fruit snacks, starch based jellies, gelatin based jellies, pectin based jellies, carageenan based jellies, agar based jellies, konjac based jellies, jelly beans, chewy candy, starch candy, nougat, nougatine, toffee, taffy, marshmallow, fondant, fudge, marzipan, chocolate, compound coating, carob coating, chewing gum, and caramel. Also included are confections such as compressed tablets, candy floss (also known as cotton candy), hard boiled candy, nut brittles, pastilles, pralines, nonpareils, dragees, lozenges, sugared nuts, comfits, aniseed balls, and chewing gum. The base of the confectionery may be a sugar/glucose syrup combination or a polyol/polyol syrup combination and a gelatinizing agent, the latter of which may be gelatin, agar, gum arabic, maltodextrin, pectin, modified starches or combinations thereof. Various other gums (also referred to as hydrocolloids) may also be used. The gelatinizing material may be desirably dissolved in water or otherwise hydrated prior to mixing with the sugar/glucose syrup combination. If a hydrocolloid such as pectin is used as the gelatinizing agent, then the pectin is desirably dry mixed with a portion of the sugar or bulk sweetener prior to addition of the dry mixture to water.

The confectionery base may further include colors and/or flavors, including fruit juice concentrate. The confectionery base may additionally include acids, such as citric acid or other acids.

The confectionery base may be prepared using standard techniques and equipment known to those skilled in the art. The apparatus useful in accordance with the embodiments described herein includes mixing and heating apparatus well known in the confectionery manufacturing arts, and therefore the selection of the specific apparatus will be apparent to the artisan. Confectionery base products can include processing steps for forming the confectionery products. Such forming processes can result in the formation of individual pieces or the formation of confectionery units from which individual pieces can be derived by subsequent processes such as cutting, tearing, molding, etc.

### Chewing Gum Compositions

The confectionery composition may include a chewing gum composition. Chewing gum compositions may be provided in a variety of different forms, such as, for example, slab, pellet, sticks, balls, cubes, center-fill gums, candy gum, multi-layer gum, deposited gums and compressed gums. The chewing gum compositions also may include at least one flavor and a variety of optional additives.

In some embodiments, the confectionery base includes an elastomer region such as a chewing gum base. The gum base may include any component known in the chewing gum art. Such components may be water soluble, water-insoluble or a combination thereof. For example, the gum base may include elastomers, bulking agents, waxes, elastomer solvents, emulsifiers, plasticizers, fillers and mixtures thereof.

The elastomers (rubbers) employed in the gum base will vary greatly depending upon various factors such as the type of gum base desired, the consistency of gum composition desired and the other components used in the composition to make the final chewing gum product. The elastomer may be any water-insoluble polymer known in the art, and includes those gum polymers utilized for chewing gums and bubble gums. Illustrative examples of suitable polymers in gum bases include both natural and synthetic elastomers. For example, those polymers which are suitable in gum base compositions include, without limitation, natural substances (of vegetable origin) such as chicle, natural rubber, crown gum, nispero, rosidinha, jelutong, perillo, niger gutta, tunu, balata, guttapercha, lechi capsi, sorva, gutta kay, and the like, and mixtures thereof. Examples of synthetic elastomers include, without limitation, styrene-butadiene copolymers (SBR), polyisobutylene, isobutylene-isoprene copolymers, polyethylene, polyvinyl acetate and the like, and mixtures thereof.

The amount of elastomer employed in the gum base may vary depending upon various factors such as the type of gum base used, the consistency of the gum composition desired and the other components used in the composition to make the final chewing gum product. In general, the elastomer will be present in the gum base in an amount from about 10% to about 60% by weight, desirably from about 35% to about 40% by weight.

In some embodiments, the gum base may include wax. It softens the polymeric elastomer mixture and improves the elasticity of the gum base. When present, the waxes employed will have a melting point below about 60° C., and preferably between about 45° C. and about 55° C. The low melting wax may be a paraffin wax. The wax may be present in the gum base in an amount from about 6% to about 10%, and preferably from about 7% to about 9.5%, by weight of the gum base.

In addition to the low melting point waxes, waxes having a higher melting point may be used in the gum base in amounts up to about 5%, by weight of the gum base. Such high melting waxes include beeswax, vegetable wax, candelilla wax, carnuba wax, most petroleum waxes, and the like, and mixtures thereof.

In addition to the components set out above, the gum base may include a variety of other ingredients, such as components selected from elastomer solvents, emulsifiers, plasticizers, fillers, and mixtures thereof.

The gum base may contain elastomer solvents to aid in softening the elastomer component. Such elastomer solvents may include those elastomer solvents known in the art, for example, terpinene resins such as polymers of alpha-pinene or beta-pinene, methyl, glycerol and pentaerythritol esters of rosins and modified rosins and gums such as hydrogenated, dimerized and polymerized rosins, and mixtures thereof. Examples of elastomer solvents suitable for use herein may include the pentaerythritol ester of partially hydrogenated wood and gum rosin, the pentaerythritol ester of wood and gum rosin, the glycerol ester of wood rosin, the glycerol ester of partially dimerized wood and gum rosin, the glycerol ester of polymerized wood and gum rosin, the glycerol ester of tall oil rosin, the glycerol ester of wood and gum rosin and the partially hydrogenated wood and gum rosin and the partially hydrogenated methyl ester of wood and rosin, and the like, and mixtures thereof. The elastomer solvent may be employed in the gum base in amounts from about 2% to about 15%, and preferably from about 7% to about 11%, by weight of the gum base.

The gum base may also include emulsifiers which aid in dispersing the immiscible components into a single stable system. The emulsifiers useful in this invention include glyceryl monostearate, lecithin, fatty acid monoglycerides, diglycerides, propylene glycol monostearate, and the like, and mixtures thereof. The emulsifier may be employed in amounts from about 2% to about 15%, and more specifically, from about 7% to about 11%, by weight of the gum base.

The gum base may also include plasticizers or softeners to provide a variety of desirable textures and consistency properties. Because of the low molecular weight of these ingredients, the plasticizers and softeners are able to penetrate the fundamental structure of the gum base making it plastic and less viscous. Useful plasticizers and softeners include lanolin, palmitic acid, oleic acid, stearic acid, sodium stearate, potassium stearate, glyceryl triacetate, glyceryl lecithin, glyceryl monostearate, propylene glycol monostearate, acetylated monoglyceride, glycerine, and the like, and mixtures thereof. Waxes, for example, natural and synthetic waxes, hydrogenated vegetable oils, petroleum waxes such as polyurethane waxes, polyethylene waxes, paraffin waxes, microcrystalline waxes, fatty waxes, sorbitan monostearate, tallow, propylene glycol, mixtures thereof, and the like, may also be incorporated into the gum base. The plasticizers and softeners are generally employed in the gum base in amounts up to about 20% by weight of the gum base, and more specifically in amounts from about 9% to about 17%, by weight of the gum base.

Plasticizers also include hydrogenated vegetable oils, such as soybean oil and cottonseed oils, which may be employed alone or in combination. These plasticizers provide the gum base with good texture and soft chew characteristics. These plasticizers and softeners are generally employed in amounts from about 5% to about 14%, and more specifically in amounts from about 5% to about 13.5%, by weight of the gum base.

Anhydrous glycerin may also be employed as a softening agent, such as the commercially available United States Pharmacopeia (USP) grade. Glycerin is a syrupy liquid with a sweet warm taste and has a sweetness of about 60% of that of cane sugar. Because glycerin is hygroscopic, the anhydrous glycerin may be maintained under anhydrous conditions throughout the preparation of the chewing gum composition.

In some embodiments, the gum base may also include effective amounts of bulking agents such as mineral adjuvants which may serve as fillers and textural agents. Useful mineral adjuvants include calcium carbonate, magnesium carbonate, alumina, aluminum hydroxide, aluminum silicate, talc, tricalcium phosphate, dicalcium phosphate, calcium sulfate and the like, and mixtures thereof. These fillers or adjuvants may be used in the gum base compositions in various amounts. Preferably the amount of filler, when used, will be present in an amount from about 15% to about 40%, and desirably from about 20% to about 30%, by weight of the gum base.

A variety of traditional ingredients may be optionally included in the gum base in effective amounts such as flavor agents and coloring agents, antioxidants, preservatives, and the like, some of which are described in more detail below in the section entitled “Additional Components”. For example, titanium dioxide and other dyes suitable for food, drug and cosmetic applications, known as F. D. & C. dyes, may be utilized. An anti-oxidant such as butylated hydroxytoluene (BHT), butylated hydroxyanisole (BHA), propyl gallate, vitamin E and mixtures thereof, may also be included. Other conventional chewing gum additives known to one having ordinary skill in the chewing gum art may also be used in the gum base.

In general, the gum base is present in amounts of about 5% to about 95% by weight of the chewing gum composition. More specifically, the gum base may be present in amounts of about 20% to about 60% by weight of the chewing gum composition.

Chewing gum products may be prepared using standard techniques and equipment known to those skilled in the art. The apparatus useful in accordance with the embodiments described herein includes mixing and heating apparatus well known in the chewing gum manufacturing arts, and therefore the selection of the specific apparatus will be apparent to the artisan. For general chewing gum preparation processes see U.S. Pat. Nos. 4,271,197 to Hopkins et al, 4,352,822 to Cherukuri et al and 4,497,832 to Cherukuri et al, each of which is incorporated herein by reference in its entirety.

In compressed gum formats, the gum base may be in a particulate form, such as, but not limited to, a powdered or granular gum base, as opposed to molten or thermoplastic gum base. The particulate gum base may be essentially free of water and can readily be formed into any desired shape, such as by compression.

### Center-Fill Composition

In some embodiments, the confectionery composition includes a center-fill composition. The center-fill confectionery composition may include a center-fill composition and a confectionery base region. The center-fill composition may include any conventional filling or combination of filling materials. The center-fill may be sugar or sugar-free and it may contain fat or be fat-free. Additionally, the center-fill may contain vegetable-based, dairy-based or fruit-based materials such as, but not limited to, fruit juices, fruit concentrates, fruit purees, dried fruit materials, and the like. Further, in some embodiments, the center-fill component may include one or more sweeteners such as those discussed above. The center-fill may also include one or more hydrocolloid materials. Emulsifiers can also be incorporated into the center-fill composition. Suitable emulsifiers include mono-and di fatty acid glycerides, monoglycerides esterified with citric acid, and lecithins. Suitable levels of the emulsifier are from 0.001 to about 1%, more preferably from about 0.005 to about 0.1% and especially from about 0.01 to about 0.05% by weight of the filling.

In some embodiments, center-fill hydrocolloid materials may include naturally occurring materials such as plant exudates, seed gums, and seaweed extracts or they may be chemically modified materials such as cellulose, starch, or natural gum derivatives. In some embodiments, hydrocolloid materials may include starches, flour, pectin, gum arabic, acacia gum, alginates, agar, carrageenans, guar gum, xanthan gum, locust bean gum, gelatin, gellan gum, galactomannans, tragacanth gum, karaya gum, curdlan, konjac, chitosan, xyloglucan, beta glucan, furcellaran, gum ghatti, tamarin, bacterial gums, and combinations thereof. Additionally, in some embodiments, modified natural gums such as propylene glycol alginate, carboxymethyl locust bean gum, low methoxyl pectin, and their combinations may be included. In some embodiments, modified celluloses may be included such as microcrystalline cellulose, carboxymethlcellulose (CMC), methylcellulose (MC), hydroxypropylmethylcellulose (HPMC), and hydroxypropylcellulose (MPC), and combinations thereof. In some embodiments, it is desirable to include hydrocolloid materials that increase the viscosity of the center-fill composition.

In some embodiments, the texture of the center-fill is the same as the texture of the confectionery base. In other embodiments, the texture of the center-fill is different than the texture of the confectionery base.

In some embodiments, the appearance of the center-fill is the same as the appearance of the confectionery base. In other embodiments, the appearance of the center-fill is different than the appearance of the confectionery base.

The center-fill composition may also include one or more food acids as discussed above and such as acetic acid, adipic acid, ascorbic acid, butyric acid, citric acid, formic acid, fumaric acid, glyconic acid, lactic acid, phosphoric acid, malic acid, oxalic acid, succinic acid, tartaric acid, citrates, and combinations thereof. These food acids or blends thereof may be included in amounts from about 0.5% w/w to about 5.0% w/w of the center-fill composition. In some embodiments, buffering agents such as citrates may be included.

In some embodiments, the center-fill confectionery composition may include coloring, and preservatives.

Further, in some embodiments, the center-fill composition may include functional ingredients as discussed above and such as, but not limited to, medicaments, nutrients such as vitamins and minerals and the like, nutraceuticals such as phytochemicals and the like, breath freshening agents, oral care agents, probiotic materials, prebiotic materials, taste and/or flavor potentiators, and throat care agents.

In some embodiments, the center-fill composition may include flavors and/or sensates as discussed above.

In some embodiments, the center-fill composition may be included in the dual-coated center-filled confectionery composition in amounts from about 1 percent by weight of the total composition to about 25 percent by weight of the total composition. Due to the multiple regions included in the dual-coated center-filled product, it is possible to modify the composition of the individual regions to achieve a desired effect. For example, the particulate coating may be formulated to provide a sour taste perception while the non-particulate coating, confectionery base, and center-fill may be formulated to provide a sweet taste perception. Upon consumption, a sour taste followed by a sweet taste may be perceived. In some embodiments, different flavors may be included in the different regions to provide a contrasting flavor perception or a blended flavor perception. In other embodiments, ingredients that are not compatible with each other may be placed in different regions to avoid undesirable interactions.

### Application of Particulate Coating

The particulate coating composition can be applied to the confectionery composition by any conventional means known to those of ordinary skill in the art. In an embodiment, the confectionery base composition may first be provided and formed into a unit. In some embodiments, the confectionery base is first coated with a non-particulate coating layer via conventional panning means. The non-particulate coating layer can be a soft-panned layer or a hard-panned layer. The surface of the confectionery composition with the non-particulate coating layer may then be exposed to at least one pre-conditioning step. In some embodiments, the confectionery composition may be subjected to a first pre-conditioning step, and then further subjected to at least a second pre-conditioning step. The first and at least second pre-conditioning steps may be the same step or they may be different.

In some embodiments, the pre-conditioning step enables the surface of the confectionery composition to better adhere the particulate coating composition. In one embodiment, the pre-conditioning step includes applying an aqueous solution to the surface of the confectionery product. In some embodiments, the aqueous solution can be the final application of the non-particulate coating layer. Once the aqueous solution is applied to the surface, it may then be dried for a sufficient time and temperature. In a preferred embodiment, the aqueous-coated confectionery is dried for about 1 to about 60 seconds. Preferably the aqueous-coated confectionery is dried for between about 30 to about 60 seconds. The drying step sufficiently removes enough moisture to leave the surface of the confectionery product tacky. Once dried, the particulate coating composition may be applied to the surface of the tackified confectionery product. In some embodiments, the confectionery product may be exposed to heat sufficient to tackify the confectionery piece and/or the non-particulate coating layer.

In some embodiments, a particulate coating composition may include a range of particle sizes. For example, a particulate coating composition including 33% of particles from 10-60 microns plus 33% of particles from 60-110 microns plus 33% of particles from 110 microns and above.

The confectionery base may be present in any amount from about 20% to about 80% by weight of the piece. In a preferred embodiment, the confectionery base is present in about 30% to about 50% by weight of the dual-coated candy. The non-particulate coating layer may be present in any amount from about 30% by weight to about 80% by weight of the confectionery piece. Preferably, the non-particulate coating layer is about 45% to about 65% by weight of the confectionery piece. The particulate coating layer may be present in any amount from about 5% to about 20% by weight of the piece, and preferably is present in an amount from about 5% to about 15% by weight.

The invention described above may be more readily understood by the various examples provided below. The examples are intended for the purpose of explanation and are not intended to be construed as limiting the scope of the invention in any way.

### EXAMPLES

A confectionery base is prepared. The confectionery base is first prepared according to the composition set forth in Table 1 below. The amounts included are based on the weight percent of the total confectionery base composition.

TABLE 1
Confectionery Base Composition

| | Weight Percent | | | |
|---|---|---|---|---|
| Composition | A | B | C | D |
| Cooked Starch Slurry | 15-35% | 15-35% | | |
| Chewing gum base | | | 20-60% | 20-60% |
| Glucose Syrup | 40-60% | | 5-15% | |
| Sugar | 20-40% | | 35-55% | |
| Polyol Syrup | | 40-60% | | 5-15% |
| Particulate Polyol | | 20-40% | | 35-55% |
| Fruit Juice Concentrate | 0-5.0% | 0-5.0% | 0-5.0% | 0-5.0% |
| High Intensity Sweetener | 0-1% | 0-1% | 0-1% | 0-1% |
| Food Acid(s) | 0.1-3.0% | 0.1-3.0% | 0.1-3.0% | 0.1-3.0% |
| Color(s) | 0.001-0.1% | 0.001-0.1% | 0.001-0.1% | 0.001-0.1% |
| Flavor(s) | 0.001-1.0% | 0.001-1.0% | 0.001-1.0% | 0.001-1.0% |

Optionally, the confectionery base can be prepared to include a center fill composition prepared according to the composition set forth in Table 2 below. Any of the center fill compositions of Examples E-H are incorporated into any of the confectionery base compositions of A-D. The amounts included are based on the weight percent of the total center fill composition.

TABLE 2
Center fill Composition

| | Weight Percent | | | |
|---|---|---|---|---|
| Composition | E | F | G | H |
| Sugar | 42-48 | 42-48 | | |
| Corn Syrup | 42-48 | 42-48 | | |
| Polyol (syrup or | | | 84-96 | 84-96 |
| slurry) | | | | |
| Guar Gum | 0.1-0.7 | | 0.1-0.7 | |
| Citric Acid | 0.7-4.5 | 0.7-4.5 | 0.7-4.5 | 0.7-4.5 |
| Flavor | 0.05-.30 | 0.05-.30 | 0.05-.30 | 0.05-.30 |
| Color | 0.1-0.7 | 0.1-0.7 | 0.1-0.7 | 0.1-0.7 |

The non-particulate coating layer is then prepared according to the composition set forth in Table 3 below. The amounts included are based on the weight percent of the total non-particulate coating composition.

TABLE 3
Non-Particulate Coating Layer Composition

| | Weight Percent | | | |
|---|---|---|---|---|
| Composition | I | J | K | L |
| Glucose Syrup | 65-75% | | 90-99.9% | |
| Sugar | 25-35% | | 0-9.5% | |
| Polyol Syrup | | 65-75% | | 90-99.9% |
| Particulate Polyol | | 25-35% | | 0-9.5% |
| Hydrocolloid | | | | |
| Food Acid(s) | 0-1% | 0-1% | 0-1% | 0-1% |
| Color(s) | 0.001-0.1% | 0.001-0.1% | 0.001-0.1% | 0.001-0.1% |
| Flavor(s) | 0.001-1.0% | 0.001-1.0% | 0.001-1.0% | 0.001-1.0% |
| Texture Description | Soft | Soft | Crunchy | Crunchy |

The confectionery base is panned according to conventional processes to create a soft- or hard-panned layer as desired. The non-particulate coated confectionery product is then coated with particulate coating according to the composition set forth in Table 3 below to form a dual-coated confection. The amounts included are based on the weight percent of the total particulate coating composition.

TABLE 4
Particulate Coating Layer Composition

| | M | N | O | P | Q |
|---|---|---|---|---|---|
| Sugar | 75-85 | 75-85 | | | 35-45 |
| Polyol | | | 75-85 | 75-85 | 34-45 |
| Food Acid(s) | 5-15 | 5-15 | 5-15 | 5-15 | 5-15 |
| Encapsulated | | 1-3 | | 1-3 | 1-3 |
| Food Acid(s) | | | | | |
| Color(s) | 0-0.1 | 0-0.1 | 0-0.1 | 0-0.1 | 0-0.1 |
| Flavor(s) | 0-0.5 | 0-0.5 | 0-0.5 | 0-0.5 | 0-0.5 |

The confectionery base composition ingredients in Examples A and B above are mixed together in a mixing kettle and heated to about 55° C., at which time the mixture is transported to a holding tank and heated to up to 145° C., separated into a separate holding tank, and cooled. Once the confectionery base composition reaches a temperature of about 90° C.-95° C., the composition is deposited into starch molds and dried until a desired texture is achieved. Optionally, a center-fill composition can be incorporated into the confectionery base by any known means such as one-shot depositing.

Similarly, the confectionery base ingredients in Examples C and D above are mixed together in a mixing kettle and heated to about 55° C., at which time the mixture is transported to a holding tank and heated to up to 145° C., separated into a separate holding tank, and cooled. Once the confectionery base composition reaches a temperature of about 90° C.-95° C., the composition is deposited into molds and dried until a desired texture is achieved. Optionally, a center-fill composition can be incorporated into the confectionery base by any known means such as one-shot depositing.

To prepare the non-particulate coating layer, the sugar and glucose or particulate polyol and polyol syrup, optionally mixed with hot water to adjust the syrup viscosity, are added to a syrup mixing pan and mixed thoroughly. Once mixed, flavors and colors may be added to the syrup mixture and mixed.

Confectionery base pieces are then placed in a separate pan, and the pan begins rotating. The syrup mixture may then be added to the rotating pan in amounts and rates sufficient to wet the confectionery base pieces. Once sufficiently wetted, particulate sugar or polyol may then be added to the rotating pan, and then confectionery base pieces are coated until sufficiently dry. An optional second wetting step may then commence. The second wetting step includes adding the syrup mixture at a rate and amount sufficient to wet the confectionery base pieces, at which point particulate sugar or polyol is added to the pan and rotated until the confectionery pieces are almost dry. Once almost dry, the syrup mixture may then be added again until the pieces are coated. Once the third wetting has taken place, particulate sugar or polyol may then be added to the pan and the pan is rotated until the pieces are dry.

The particulate coating composition can be applied to the non-particulate coated confectionery base composition by any conventional means known to those of ordinary skill in the art. In some embodiments, the particulate coating composition including free and/or encapsulated ingredients is in particulate form and the non-particulate coated confectionery base is subjected to a brief steam treatment prior to applying the coating. The wetted surface of the steam treated non-particulate coated confectionery base can cause the particulate coating composition including free and/or encapsulated ingredients to adhere to the surface. Alternatively, a wetting syrup including carbohydrates such as sweeteners and/or hydrocolloids can be applied to the surface of the non-particulate coated confectionery base to cause the particulate coating including free and/or encapsulated ingredients to adhere to the surface.

To form the dual-coated confectionery product, any of the center fill compositions of Examples E-H are incorporated into any of the confectionery base compositions of Examples A-D. Then any of the non-particulate coating compositions of Examples I-L together with any of the particulate coating compositions of Examples M-Q are applied to the exterior. The center fill is added in an amount from about 5% by weight to about 25% by weight of the total composition. The confectionery base is added in an amount from about 30% by weight to about 45% by weight of the total composition. The non-particulate coating is added in an amount from about 45% to about 60% and the particulate coating is added in an amount from about 5% by weight to about 15% by weight of the total composition.

What is claimed is:

1. A confectionery product comprising a confectionery base, a first non-particulate coating and a second particulate coating; wherein said second particulate coating comprises at least one encapsulated ingredient selected from the group consisting of two or more food acids, salts, sweeteners, flavors, sensates, functional ingredients, and combinations thereof.

2. The confectionery product of claim 1, wherein said confectionery base comprises a soft candy composition.

3. The confectionery product of claim 1, wherein said first non-particulate coating substantially covers said confectionery base.

4. The confectionery product of claim 3, wherein said second particulate coating substantially covers said first non-particulate coating.

5. The confectionery product of claim 1, wherein said first non-particulate coating comprises a soft panned coating.

6. The confectionery product of claim 1, wherein said first non-particulate coating comprises a hard panned coating.

7. The confectionery product of claim 1, further comprising a center-fill confectionery region.

8. The confectionery product of claim 1, wherein said confectionery base is present in an amount of from about 30% by weight to about 50% by weight of the confectionery product; said first non-particulate coating is present in an amount of from about 45% by weight to about 65% by weight of the confectionery product; and said second particulate coating is present in an amount of from about 5% by weight to about 15% by weight of the confectionery product.

9. A method of preparing a confectionery product comprising the steps of:
a. preparing a confectionery base composition;
b. forming said confectionery base composition into a unit;
c. coating said unit with a first coating; and
d. coating said first-coated unit with a second coating; wherein at least one of said first or second coating comprises a particulate coating and wherein said particulate coating comprises at least one encapsulated ingredient selected from the group consisting of two or more food acids, salts, sweeteners, flavors, sensates, functional ingredients, and combinations thereof.

10. The method of claim 9, wherein said confectionery base composition comprises a soft candy composition.

11. The method of claim 9, wherein said first coating comprises a non-particulate coating and said second coating comprises a particulate coating.

12. The method of claim 9, wherein said unit is an individual piece.

13. The method of claim 12, wherein said step of coating said individual piece with a first coating comprises soft panning said individual piece.

14. The method of claim 12, wherein said step of coating said individual piece with a first coating comprises hard panning said individual piece.

15. The method of claim 9, wherein said confectionery base is present in an amount of from about 30% by weight to about 50% by weight of the confectionery product; said first coating is present in an amount of from about 45% by weight to about 65% by weight of the confectionery product; and said second coating is present in an amount of from about 5% by weight to about 15% by weight of the confectionery product.

16. The method of claim 9, further comprising the step of wetting said unit prior to the step of coating said unit with said second coating.

17. A chewing gum composition comprising an elastomer region, a first non-particulate coating and a second particulate coating.

18. The chewing gum composition of claim 17, wherein said first non-particulate coating substantially covers said elastomer region.

19. The chewing gum composition of claim 18, wherein said second particulate coating substantially covers said first non-particulate coating.

20. The chewing gum composition of claim 17, wherein said first non-particulate coating comprises a soft panned coating.

21. The chewing gum composition of claim 17, wherein said first non-particulate coating comprises a hard panned coating.

22. The chewing gum composition of claim 17, wherein said second particulate coating comprises an acid.

23. The chewing gum composition of claim 17, wherein said second particulate coating comprises at least one encapsulated ingredient.

24. The chewing gum composition of claim 17, further comprising a center-fill region.

25. The chewing gum composition of claim 17, wherein said elastomer region is present in an amount of from about 30% by weight to about 50% by weight of the chewing gum composition; said first non-particulate coating is present in an amount of from about 45% by weight to about 65% by weight of the chewing gum composition; and said second particulate coating is present in an amount of from about 5% by weight to about 15% by weight of the chewing gum composition.

26. A method of preparing a chewing gum composition comprising the steps of:
a. preparing an elastomeric composition;
b. forming said elastomeric composition into a unit;
c. coating said unit with a first coating; and
d. coating said first-coated unit with a second coating; wherein at least one of said first or second coating comprises a particulate coating.

27. The method of claim 26, wherein said first coating comprises a non-particulate coating and said second coating comprises a particulate coating.

28. The method of claim 26 wherein said unit is an individual piece.

29. The method of claim 26, wherein said elastomeric unit is present in an amount of from about 30% by weight to about 50% by weight of the chewing gum composition; said first coating is present in an amount of from about 45% by weight to about 65% by weight of the chewing gum composition; and said second coating is present in an amount of from about 5% by weight to about 15% by weight of the chewing gum composition.

30. The method of claim 26, further comprising the step of wetting said unit prior to the step of coating said individual piece with a second coating.
